(19) United States
(12) Patent Application Publication
(10) Pub. No.: US 2024/0204379 A1
(43) Pub. Date: Jun. 20, 2024

(54) CURRENT LIMITING ELEMENT IN PARALLEL PATH FOR PREVENTION OF THERMAL RUNAWAY PROPAGATION IN BATTERY SYSTEM, PACKS AND MODULES

(71) Applicant: BAE Systems Controls Inc., Endicott, NY (US)

(72) Inventors: Joshua P. Stewart, Vestal, NY (US); Matthew S. Boecke, Endicott, NY (US); Jay R. Johnson, Vestal, NY (US); Peter J. Arnold, Endicott, NY (US)

(73) Assignee: BAE Systems Controls Inc., Endicott, NY (US)

(21) Appl. No.: 18/539,469

(22) Filed: Dec. 14, 2023

Related U.S. Application Data
(60) Provisional application No. 63/387,390, filed on Dec. 14, 2022.

(51) Int. Cl. H01M 50/583; H01M 10/42; H01M 10/48; H01M 50/213; H01M 50/503; H01M 50/509

(52) U.S. Cl. CPC H01M 50/583; H01M 10/425; H01M 10/482; H01M 50/213; H01M 50/503; H01M 50/509; H01M 2200/103; H01M 2220/20

(57) ABSTRACT

A battery system, battery packs and battery modules are disclosed. The battery module comprises a plurality of cells mounted within a housing. The housing has a plurality of openings respectively for a corresponding cell. The module has a plurality of groups of cells. Each group comprises a plurality of parallel connected cells from among the plurality of cells. The plurality of groups is connected in series. The module has a plurality of current limiting elements. Each current limiting element are electrically connected in a parallel path to one or both terminals of cells which are parallelly connected. The current limiting elements may be passive or active elements. The current limiting elements may be integrated in or separate from busbars which are connected to terminals of the cells.

### CROSS REFERENCE TO RELATED APPLICATIONS

This application claims the benefit under 35 U.S.C. § 119(e) of U.S. Provisional Application Ser. No. 63/387,390, filed Dec. 14, 2022. The entire contents and disclosure of the aforementioned provisional application is incorporated by reference as if fully set forth herein.

### FIELD OF THE DISCLOSURE

This disclosure relates to battery modules having a plurality of cells, where cells are parallelly connected in groups, which are serially connected to form the module, and where modules may be connected in series to form a pack and the packs may be connected in parallel to form a battery system. More particularly, this disclosure relates to protection against thermal runaway in the modules, packs and battery systems.

### BACKGROUND

A Battery module is comprised of a plurality of cells. The cells may be electrically connected in parallel to form a group. Each group may be connected in series. However, each cell may be susceptible to an event, which may be thermal, electrical, or mechanical, which leads to spontaneous heat generation and rapid self-heating, emission of debris, smoke, and flames, also known as thermal runaway. The event in one cell may spread to another cell and propagate though the module and subsequently from module-to-module etc. . . . . This spreading of thermal runway from cell to cell is known as “propagation” of thermal runaway.

There are several modes of “propagation”. One mode may be heat transfer from cell to cell, either through the interstitial material or air gap, through a busbar connected to the cell and other cells, or through any other conduction path between cells. Insulating tape, tubes, paper, or plates may be used to provide a heat transfer barrier. The insulating tape may be mica tape.

Another mode is direct impingement of flame or heated material from one cell to another. The event may include a release of ejecta and flames from a designed cell vent, or from a pin hole forming in any location on the cell. The flame or ejecta may subsequently impinge on another cell, leading to propagation of thermal runaway. Some systems may use ceramic papers, insulating foams, and other materials to provide a barrier to these flames and ejecta.

Another mode of thermal runaway propagation is heating of the cell or cell group due to a short circuit event in a cell or an ejecta-created path which converts electrical energy into thermal energy. The cells in parallel with the shorted cell discharge through the short, producing ohmic heating and sometimes arcing. This heating can sustain flames and inject enough heat into the affected cells to result in propagation. Aspects of this disclosure pertain to mitigating this mode of thermal runaway propagation.

Certain battery modules have current limiting elements within each cell, or in the busbar attached to each cell in the series path. These individual cell level current limiting elements may mitigate propagation of thermal runaway due to parallel short circuit current. However, the use of current limiting elements at the cell level increases the resistance and voltage drop (and losses) in the cell under normal operation because these fuses limit current in the series path. This reduces the overall performance of the battery module, pack, and system.

### SUMMARY

Accordingly, aspects of the disclosure provide current limiting elements, either passively or actively, mitigating thermal runaway propagation by limiting short circuit current in the parallel path within a cell group, without limiting the normal operating charge/discharge current in the series path.

Disclosed is a battery module which comprises a plurality of cells, a plurality of groups of cells and a plurality of current limiting elements. The plurality of cells is mounted with a cell housing. The cell housing has a plurality of openings for a corresponding cell. Each group of cells comprises a plurality of parallel connected cells from among the plurality of cells. The plurality of groups is connected in series. Each current limiting element is electrically connected in a parallel path to one or both terminals of cells which are parallelly connected.

In an aspect of the disclosure, the battery module further comprises busbars connecting cells. The busbars may comprise a first set of busbars and a second set of busbars. The first set of busbars and the second set of busbars are connected to terminals of the cells. In an aspect of the disclosure, the plurality of current limiting elements may be integrated into first set of busbars, the second set of busbars or both the first set of busbars and the second set of busbars.

In an aspect of the disclosure, each cell has a first end and a second end. In an aspect of the disclosure, the cell terminals, e.g., positive and negative terminals may be positioned on different ends of the cells. The first set of busbars may be positioned on the first end of the cells. In an aspect of the disclosure, the second set of busbars may be positioned on the second end. In accordance with aspects of the disclosure, the plurality of current limiting elements may be connected to both terminals of the cells and integrated into both the first set of busbars and the second set of busbars.

In other aspects of the disclosure, the cell terminals are positioned on the same end of the cell such that the positive and negative terminals of the same cell as on the same end. In an aspect of the disclosure, the battery module may have a plurality of busbars including a first busbar and a second busbar, The first busbar may be electrically connected to the positive terminal of a first cell and the negative terminal of a second cell. This connection forms a series connection between the first cell and the second cell. The second busbar may be electrically connected to the positive terminal of third cell and the negative terminal of a fourth cell. This connection forms a series connection between the third cell and the fourth cell. In an aspect of the disclosure, current limited elements may be positioned in the parallel path between the first cell and the third cell and the second cell and the fourth cell, respectively and connected to the positive and negative terminals of the first cell, the second cell, the third cell and the fourth cell.

The plurality of current limiting elements according to aspects of the disclosure is configured to prevent thermal runaway from propagating from one cell to another cell.

In some aspects of the disclosure, the current limiting elements may be passive elements such as a fuse or a circuit breaker. Each fuse may connect adjacent parallelly connected cells and according to aspects of the disclosure, each fuse may be offset with the openings in the housing.

In an aspect of the disclosure, a short circuit current seen by each fuse for the same group is the same for all of cells within the group. However, in other aspects, the short circuit current may be different for each fuse within the same group depending on the cell having the fault.

In some aspects of the disclosure, the fuse may be a wire in the parallel path of the parallel connected cells and each wire may be connected to busbars which are connected to the cells.

In other aspects of the disclosure, the plurality of current limiting elements may be an active element such as semiconductor switches, relays, or contactors.

In an aspect of the disclosure, the battery module may further comprise a processor configured to control the active element to open upon a detection of an event by a sensor. In other aspects, the processor may be incorporated in a battery management system.

In some aspects of the disclosure, the battery module may further comprise one or more sensors such as voltage, current, temperature and/or gas sensors.

Also disclosed is a battery pack comprising a plurality of battery modules in accordance with one or more aspects of the disclosure. The battery modules are connected in series to form the battery pack.

Also disclosed is a battery system comprising a plurality of battery packs in accordance with one or more aspects of the disclosure. The battery packs are connected in parallel to form the battery system.

Also disclosed is an airplane comprising a battery system in accordance with one or more aspects of the disclosure. The battery system may be used to supply power for propulsion.

Also disclosed is a battery module comprising a plurality of cells, a plurality of groups of cells and a plurality of fuses. The plurality of cells is mounted with a cell housing. The cell housing has a plurality of openings for a corresponding cell. Each group of cells comprises a plurality of parallel connected cells from among the plurality of cells. The plurality of groups is connected in series. Each fuse is electrically connected in a parallel path to one or both terminals of cells which are parallelly connected.

### BRIEF DESCRIPTION OF DRAWINGS

FIG. 1 illustrates a schematic diagram of a battery module with thermal runaway protection in accordance with aspects of the disclosure;

FIG. 2 illustrates a busbar with an integrated fuse in the parallel path in accordance with aspects of the disclosure;

FIG. 3A illustrates an example of a first set of busbars with fuses where a second set of busbars are unfused in accordance with aspects of the disclosure;

FIG. 3B illustrates an example of a first set and a second set of busbars with fuses in accordance with aspects of the disclosure;

FIG. 4A illustrates an exploded view of another example of busbars with fuses in accordance with aspects of the disclosure;

FIG. 4B illustrates another view of the same busbars in FIG. 4A in accordance with aspects of the disclosure;

FIG. 4C illustrates a close up view of FIG. 4B showing the connections in accordance with aspects of the disclosure;

FIG. 5 illustrates an example of the thermal runaway protection in accordance with aspect of the disclosure when one of the cells in a group of parallel connected cells has an internal short;

FIG. 6 illustrates a schematic diagram of a battery module with thermal runaway protection in accordance with other aspects of the disclosure;

FIG. 7 illustrates a block diagram of a control of the active current limiting element in accordance with aspects of the disclosure;

FIG. 8 illustrates an example of a busbar with integrated fuse after the integrated fuse has blown in accordance with aspects of the disclosure to prevent thermal runaway;

FIG. 9 illustrates another example of a busbar with an integrated fuse in the parallel path connected to groups of cells in accordance with aspects of the disclosure; and

FIG. 10 illustrates an example of the busbar of FIG. 9 after the integrated fuse has blown in accordance with aspects of the disclosure to prevent thermal runaway.

### DETAILED DESCRIPTION

A battery module 100 may comprise a plurality of cells 25. The cells 25 may be connected in parallel to form a cell group 10. Cell groups 10 may be connected in series to form the battery module 100. The plurality of groups 1-N are connected to the module terminals 75. The modules 100 may be connected in series to form a battery pack via the module terminals 75. The battery pack may be connected in parallel with other battery packs to for a battery system.

The number of cells 25 connected in a group 10, the number of groups 10 connected in series to form the module 100, the number of modules 100 connected in series to form a pack and the number of packs connected in parallel to for the battery system may be application specific based on the current and voltage needs of the application. Higher voltage applications such as powering a propulsion system for a vehicle may require many modules and packs.

The battery module 100 (packs and system) may be used for many different applications. For example, the battery module 100 (packs and system) may be installed in a vehicle. The vehicle may be a personal vehicle, such as a scooter, car, motorcycle and truck or a commercial vehicle such as a truck or bus, a maritime vehicle has as a boat or submarine or a military vehicle such as a tank. In other aspects of the disclosure, the battery modules 100 (packs and system) may be used in an airplane or a helicopter. The battery module 100 may be used for propulsion power (main or supplemental) or auxiliary power for accessories.

In other aspects of the disclosure, the battery module 100 (packs and system) may be used for tools, industrial machinery and assembly lines, hand-held power tools such as drills and saws, lawn equipment such as string trimmers and blowers, home cleaning equipment such as vacuum cleaners, or other home appliances.

In accordance with aspects of the disclosure, currently limiting elements, whether passive 50 or active 650, are positioned within a parallel path between parallelly connected cells. These current limiting elements 50, 650 react to an event and mitigate propagation, protecting cells 25 within the module 100 from thermal runaway. The current limiting element may be connected to the positive terminal of a cell, the negative terminal of a cell, or both the positive terminal of a cell and the negative terminal of the cell.

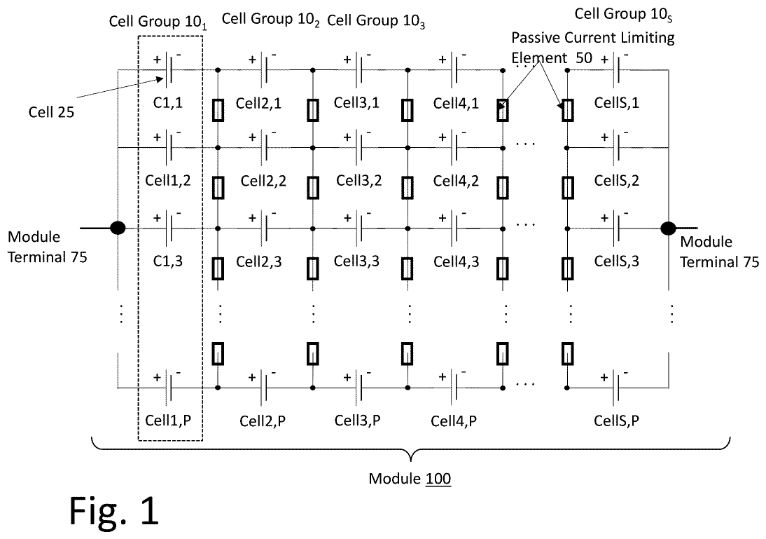

FIG. 1 illustrates an example of protection for thermal runaway using a passive current limited 50 in accordance with aspects of the disclosure. In FIG. 1, P cells are connected in parallel to form a cell group 10, where P is the number of parallelly connected cells. S groups of cells are connected in series, where S is the number of groups connected in series. The module 100 has S*P number of cells 25. For purposes of the description, the cell may be identified by C1, 1 through CellS, P. The first number/letter refers to the group and the second refers to the cell within the group so for example, C1,3 is the third cell in the first group. The cells 25 are connected between module terminals 75. A passive current limiting element (current limiter 50) is positioned in the parallel path of between the parallelly connected cells 25. The fuses do not limit current in the series path. In FIG. 1, a passive current limiting element 50 is connected to both the positive and negative terminals of the cells. However, as noted above, the passive current limited element 50 may only be connected to one of the terminals and not both.

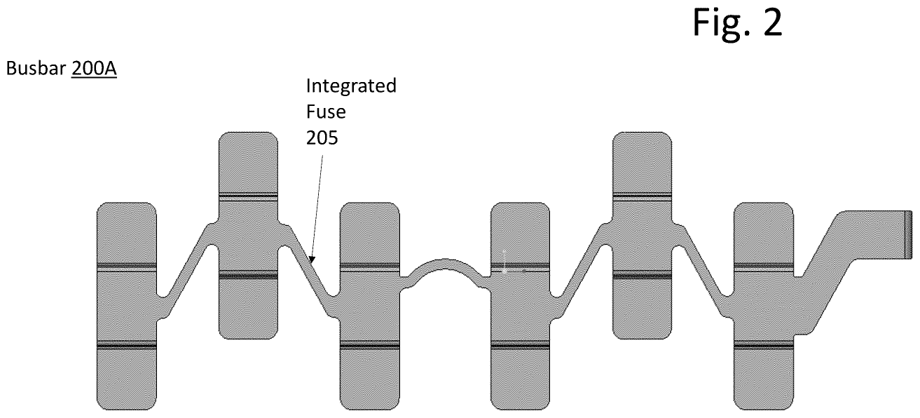

In some aspects of the disclosure, the passive current limiting element 50 may be fuse. The fuse may be made of a conductive material. In some aspects of the disclosure, as shown in FIG. 2, the fuse 205 may be integrated into a busbar 200A. A busbar is a structure, or assembly of sub-structures, which make electrical connections between elements.

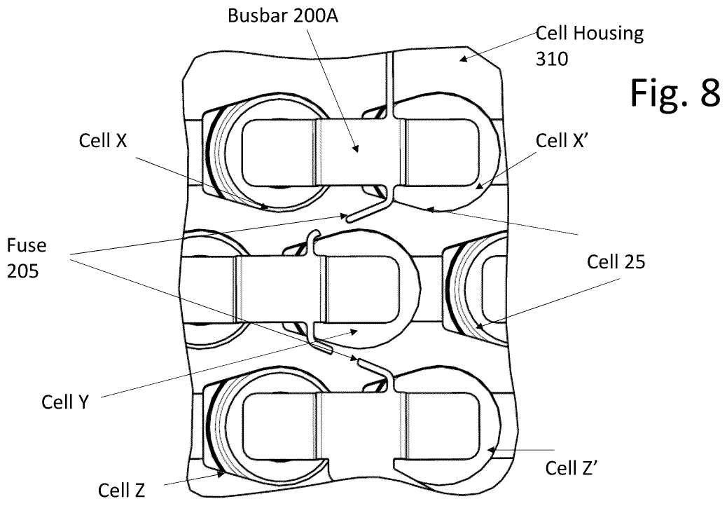

The length of the fuse may be based on the spacing between adjacent parallel connected cells (e.g., C1, 1 and C1, 2). The fuse may be designed to force current flowing into a narrow geometry (width) to produce melting (cracking/breaking) to disconnect under the event conditions (such as thermal runway initiated parallel short circuit currents) such as shown in FIG. 8. In the example shown in FIG. 8, a thermal event occurred in Cell Y. As illustrated in the example, the fuse 205, connected in the parallel path between Cell Y and Cells X, X′, Z, Z′, broke thus electrically disconnecting Cell Y from its adjacent cells in the parallel direction. FIG. 8 shows the integrated fuse after it has blown due to the thermal event. Therefore, any thermal event occurring in Cell Y is not spread to the adjacent Cells X, X′, Z, Z′ (in the parallel direction) in the group(s) connected to the busbar 200A. FIG. 8 is a partial view of the busbars 200A and cell groups 10 connected to the same.

The integrated fuse 205 may be a thinner portion of the busbar 200A. The integrated fuse 205 may be fabricated with the same material as the busbar 200A. For example, the integrated fuse 205 may be made from aluminum. However, the material used for the integrated fuse 205 is not limited to aluminum and other conductive materials may be used, such as but not limited to copper and nickel. The fuse may also be welded to the busbar or mounted to the same to form the integration.

The fuse bulk temperature T is the melting temperature of the fuse. When this temperature is reached, the electrical connection is broken. T is defined by the following equation

$$T = {T}_{0} + Δ T where {T}_{0} is initial ( ° C . ) and \qquad ( 1 )$$

$$Δ T is defined by Δ T = φ {I}^{2} t or \qquad ( 2 A )$$

$$Δ T = \frac{Q}{m * {C}_{p}} t \qquad ( 2 B )$$

Q is loss (W), m is bulk mass of fuse (kg), I is the parallel cell short circuit current and t is time. The parallel cell short circuit is a system parameter based on the design of the module 100. T is a reaction time (melting time and isolation time).

Q and φ are based on the material properties and design.

$$φ = \frac{ρ}{{W}^{2} {H}^{2} D {C}_{p}} \qquad ( 3 )$$

ρ is the resistivity of the material. W is the width of the fuse (meters); H is the height (meters), and D is the density of the material (kg/m³). Cₚ is bulk specific heat capacity (J/kgK).

$$ρ = {ρ}_{ref} [ 1 + α ( T - {T}_{ref} ) ] \qquad ( 4 )$$

ρ_{ref} is the reference resistivity of the fuse base material at a reference temperature, T_{ref} (° C.), and α is the temperature coefficient of electrical resistivity (1/° C.)
Q is the heat generated in the fuse by the parallel short circuit current in Watts (W)

$$Q = {I}^{2} R \qquad ( 5 )$$

The bigger the cross-sectional area of the fuse, the longer it takes to reach the fuse bulk temperature and isolate a cell 25. For example, an aluminum fuse with a length of 10 mm and a parallel cell short circuit current of about 20 A and a cross-sectional area of about 0.7 mm² will melt and isolate in about 30 seconds, whereas the same fuse with a cross-section area of about 0.3 mm² will melt and isolate in less than 10 seconds (for the same length and parallel cell short circuit current).

A higher parallel cell short circuit current will cause the same fuse (cross-sectional area and length) to melt and isolate quicker. For example, an aluminum fuse with a length of 10 mm and a cross-sectional area of about 0.6 mm² will melt and isolate in about 60 seconds for a parallel cell short circuit current of about 12 A, whereas the same fuse will melt and isolate in about 10 second with a parallel cell short circuit current of about 30 A.

The target time required to isolate (melt) may be based on the mechanical and electrical design of the module, and the application and critically of the power function. Certain module designs may be able to tolerate a cell short circuit current longer than other designs. For example, a module design with large separation between cells would tolerate longer fuse times and therefore extended short circuit cell heating. Certain applications may be able to tolerate a cell short current longer than other applications. For example, certain applications may allow for t to be over 1 minute or 2 minutes. However, other applications may dedicate that the isolation to prevent thermal runaways is less than 10 seconds.

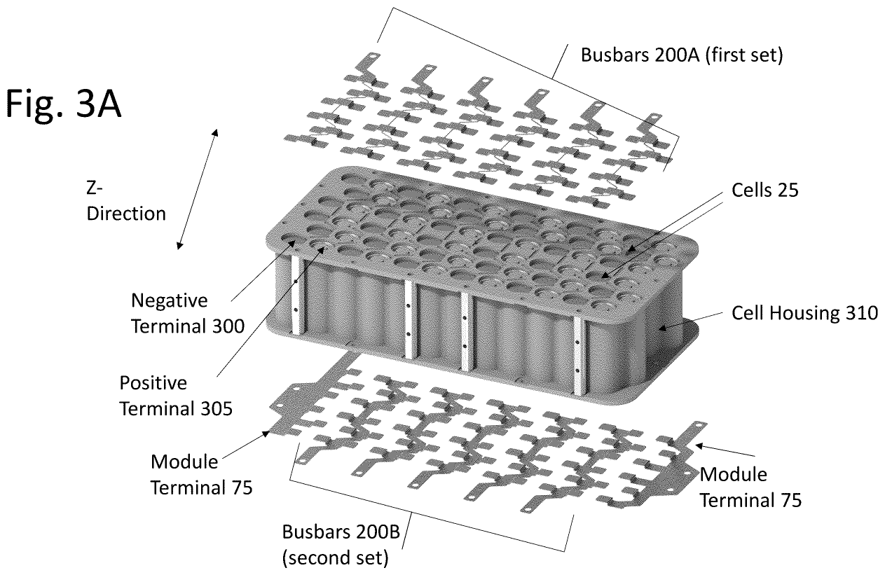

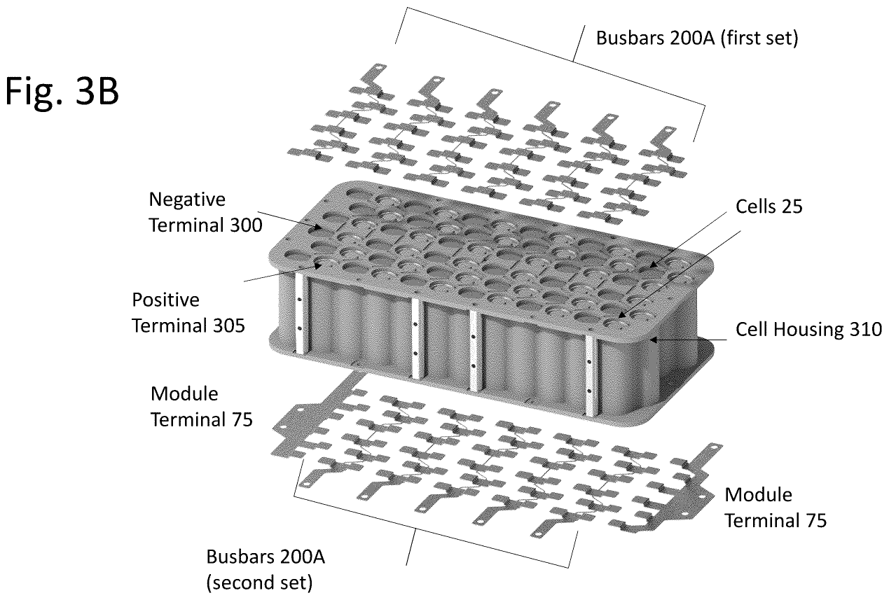

In an aspect of the disclosure, the cells 25 may be arranged in a cell housing 310. The cell housing 310 may have a plurality of openings extending in the z-axis direction (Z-direction) (shown in FIG. 3A). The cell 25 and corresponding opening may be cylindrical. However, the cell 25 is not limited to being cylindrical and cells may have a different shape. Each cell 25 has a positive terminal 305 and a negative terminal 300. In some aspects of the disclosure, the positive terminal 305 may be at a first end in the z-direction and the negative terminal 300 at a second end of the cell in the z-direction. The cells 25 may be positioned within the openings of the cell housing 310 in different orientations. For example, the cell 25 may positioned with the positive terminal 305 facing a first direction and another cell 25 may be positioned with the positive terminal 305 facing a second direction opposite of the first direction. In some aspects of the disclosure, the direction may alternate. For example, as shown in FIG. 3A, a first row of cells has its positive terminal 305 facing a first direction and the second row of cells has its positive terminal 305 facing a second direction opposite to the first direction.

FIG. 3A illustrates an exploded view showing an example of a first set of busbars 200A having integrated fuses 205 and a second set of busbars 200B not having the integrated fuses (or any fusing). In this aspect of the disclosure, only the positive terminal 305 or negative terminal 300 of a cell 25 has the fuse 205 in its parallel path between parallelly connected cells 25. In this configuration, a busbar 200A is in connection with 12 cells: parallelly connecting two sets of 6 cells and also serially connecting the two sets of cells. In the first row, the busbar 200A is connected to the negative terminal 300 and in the second row, the busbar 200A is connected to the positive terminal 305.

In this configuration, on the opposite side of the cells 25 in the z direction, the second set of busbars 200B are offset by a row with respect to the first set of busbars 200A. For example, a busbar 200B is connected to cells 25 in the second row and third row. This busbar 200B is connected to the negative terminal 300 of the cells in the second row and the positive terminal 305 of the cells in the third row.

The module terminal bars (75) are also shown in FIG. 3A.

The busbars 200A and 200B also have an opening on one end. This opening is for connecting a respective busbar to a battery management system (BMS) (not shown) for cell balancing and cell voltage monitoring.

In other aspects of the disclosure, all the busbars (both a first set and a second set) (except the module terminal bars 75) may have fuses in the parallel path between parallel connected cells as shown in FIG. 3B. It is noted that in this configuration, the first row of cells and the last row of cells only has one of the busbars 200A connected to the cells and the other side is connected to the module terminals 75 and thus, only one terminal has the integrated fuse in the parallel path between the parallel connected cells.

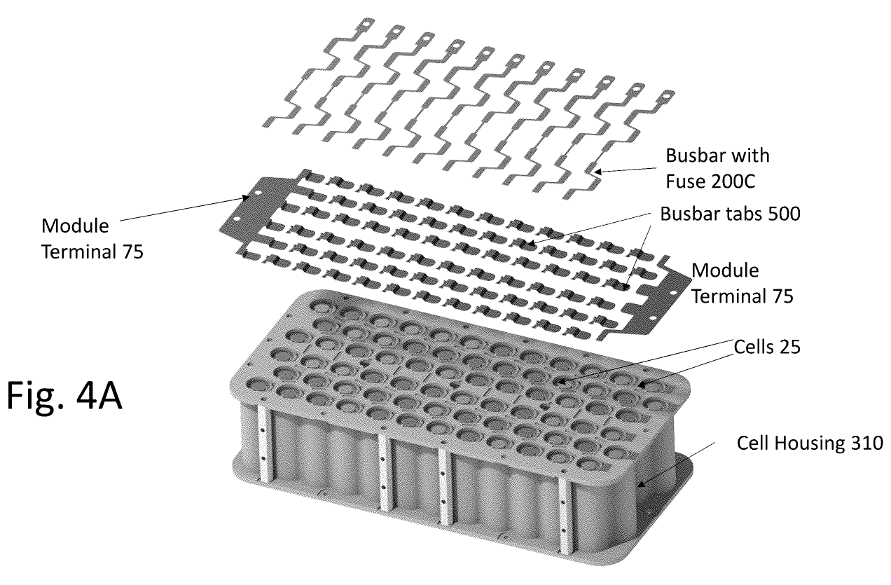

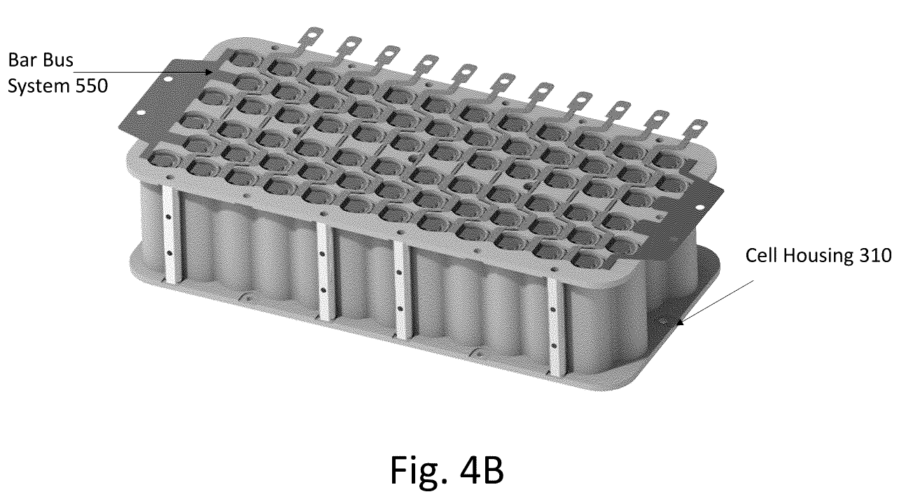

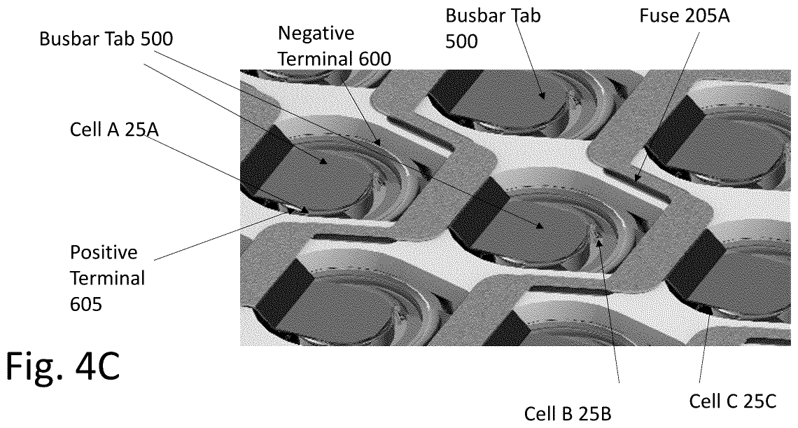

In other aspects of the disclosure, instead of the positive terminal 305 and the negative terminal 300 of a cell 25 being on different sides of the cell 25 in the z-direction, the positive terminal 605 and the negative terminal 600 may be on the same side in the z-direction such as shown in FIGS. 4A-4C.

As shown in FIG. 4C, the positive terminal 605 may be centrally located on the cell 25, e.g., a central button. The negative terminal 600 may be located on the circumference of the cell can. For example, the negative terminal 600 may be a ring around the edge of the cell 25. There may be air space between the positive terminal 605 (button) and the negative terminal 600 (ring).

The cells 25 may be serially connected via busbar tabs 500. The busbar tabs 500 may be connected to terminals of different cells. For example, cell A may be serially connected with cell B via a busbar tab 500 where the tab is connected to the negative terminal 600 of cell A and the positive terminal 605 of cell B. Similarly, a third cell may be serially connected to cell A and cell B (Cell C) via a second busbar tab 500 connecting the negative terminal 600 of cell B and the positive terminal 605 of cell C. The cells 25 in the first row and the last row of the module 100 are connected to the module terminals 75, respectively as shown in FIGS. 4A (exploded view) and 4B.

The parallel path between the cells 25 (parallelly connected cells) may be created by a busbar with fuse 200C as shown in FIGS. 4A-4C. The busbar with fuse 200C may be welded (or any other method of joining) to the busbar tabs 500 to form an electrical connection. The busbar with fuse 200C may have a meandering path that does not overlap with the openings in the cell housing 310. When connected to the busbar tabs 500, the fuse 205A is in the parallel path between parallelly connected cells. FIG. 4C shows the narrow section or bridge between adjacent cells which is the fuse section (fuse 205A) of the busbar with fuse 200C. The width and the height of the narrow section or bridge may be determined as described above and set based on a target response time and parallel cell short circuit current. The length may be based on the cell 25 arrangement within the module. The busbars with fuse 200C also have an opening on one end. This opening is for connecting a respective busbar with fuse to a battery management system (BMS) (not shown) for cell balancing and cell voltage monitoring.

The busbar with fuse 200C, the busbar tabs 500 and the module terminals 75 collectively form the busbar system 550 for the module forming the series and the parallel connections.

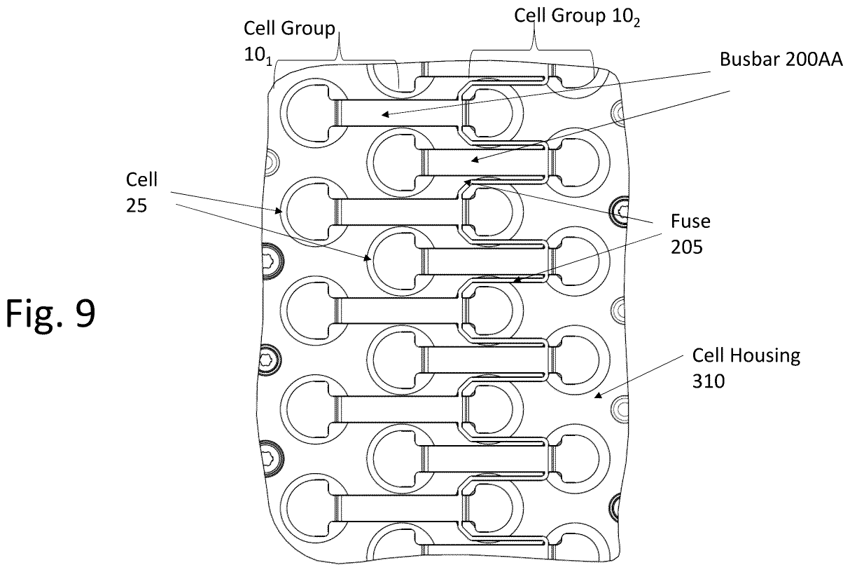

FIG. 9 illustrates a partial view of another example of a busbar 200AA with an integrated fused 205 in accordance with aspects of the disclosure. In an aspect of the disclosure, cells 25 in a cell group 10 may be arranged in multiple rows of cells and is not limited to being arranged in a single row. For example, as shown in FIG. 9, a cell group 10₁ has cells 25 arranged in two rows and cell group 10₂ has cells 25 also arranged in two rows. Thus, the busbar 200AA illustrated in the example in FIG. 9 may be connected to cells 25 in four rows (to connect the two cell groups 10₁ and 10₂). A cell group 10 may have cells from any number of adjacent rows and are not limited to the examples depicted. In FIG. 9, the fuse 205 has a C-shape and goes partially around the periphery of the cell 25. The fuse 205 is in the parallel path of parallelly connected cells 25.

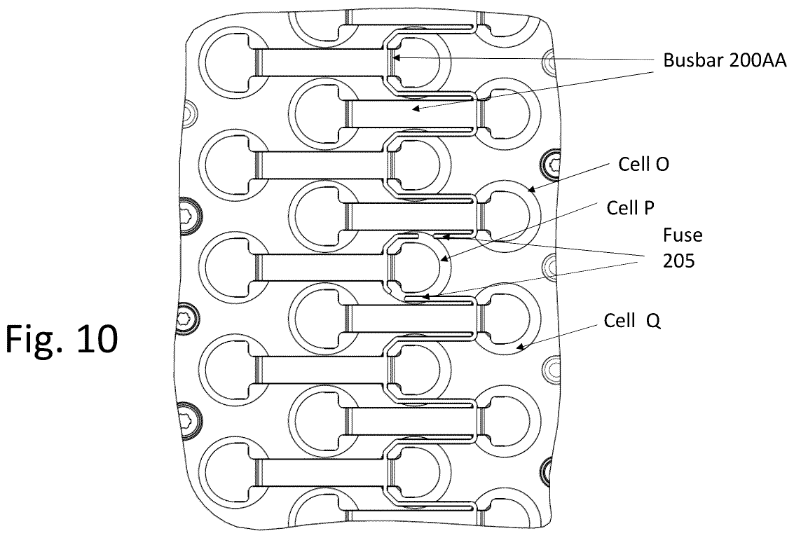

FIG. 10 illustrates an example of the fuse 205 after it has blown in response to a thermal event. In the example illustrated in FIG. 10, the thermal event occurred in Cell P. As illustrated, the fuse 205 in the parallel path of Cell P broke in two places, electrically disconnecting cell P from the parallel path in the cell group 10₂. Since Cell P is disconnected (in the parallel direction), the thermal event will not spread in the parallel direction to the adjacent cells Cell O and Cell Q in the cell group 10₂.

The passive current limiting element 50 in accordance with aspects of the disclosure is not limited to a “bar” form. In other aspects of the disclosure, the fuse may be a wire connected in the parallel path between parallel connected cells. For example, busbar tabs 500 may be used to create the serial connection between cells 25 such as shown in FIGS. 4A-4C. However, wires may be electrically connected to the busbar tabs 500 instead of the busbar with fuse 200C to make the parallel connection. The wire may be a gage wire and wire bond. In other aspects of the disclosure, the fuse may be embedded in a printed circuit board (PCB). The PCB may be rigid or flexible. The fuse may be a flexible or rigid trace in the PCB.

Once again, the height and width of the wire or trace may be determined as described above and set based on a target response time and parallel cell short circuit current. Additionally, the height and width of the fuse may depend on the material used for the conductive element of the wire or trace.

The length may be based on the cell 25 arrangement within the module.

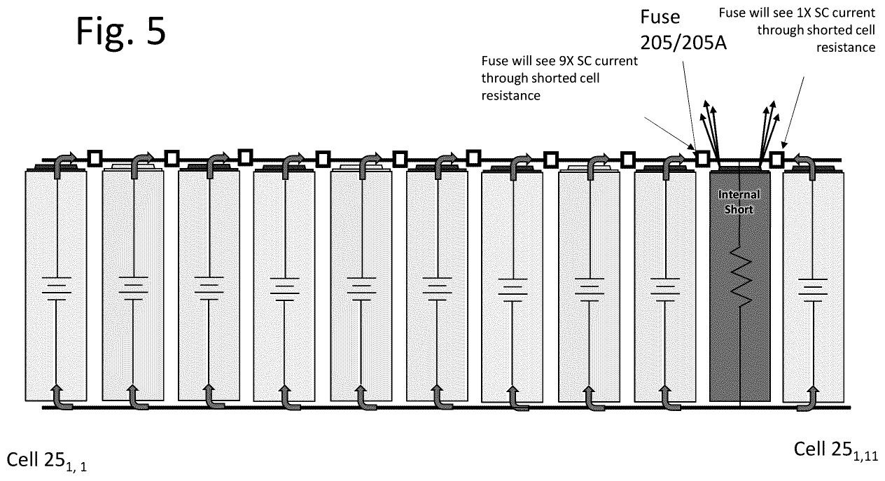

FIG. 5 illustrates an example of current paths when one of the parallelly connected cells in a group has a short. As illustrated the group (e.g., group 1) has 11 cells connected in parallel Cell 25_{1, 1} through Cell 25_{1, 11}. The amount of current seen by the fuse 205/205A (or a separate fuse) may depend on which cell 25 in the group 10₁ had the short. In this case, where cell 25_{1,10} has the short, the fuse between cell 25_{1, 9} and 25_{1, 10} will see the current flow from cells 25_{1,1}-25_{1,9}. Thus, the fuse will see 9×the parallel cell short circuit current and will break before the fuse between cell 25_{1,10} and 25_{1,11}, which only see the current from cell 25_{1,11} (when all of the fuses have the same design, e.g., material, length, width and height). The lines projecting from cell 25_{1,10} represent ejecta which may be caused by the short.

In other aspects of the disclosure, to balance the current path in a case of a short, the end the cells 25 within a specific group, e.g., 10_{1,1} and 10_{1,11} may be connected via a fused wire to provide a current path. In this case, it would not matter which cell 25 within the group 10 had the short, each fuse 205/205A (or a separate fuse) would see the same parallel cell short circuit current.

In other aspects of the disclosure, the fuse may be a commercial off the shelf (COTS) fuse selected based on its rating.

Other passive current limiting elements 50 may be used instead of a fuse. For example, a circuit breaker may be used. The circuit breaker may react to thermal effects or magnetic effects of the event and open. In some aspects of the disclosure, the circuit breaker may have a solenoid to trip the mechanism in the circuit breaker. In advantage of using a circuit breaker as the passive current limiting element 50 versus a fuse, is the trip or opening of the path is reversible, either manually or automatically when the event is no longer occurring, whereas the fuse must be replaced. Therefore, when the fuse 205/205A is integrated into a busbar 200/200CA, the whole busbar 200A/200C may have to be replaced.

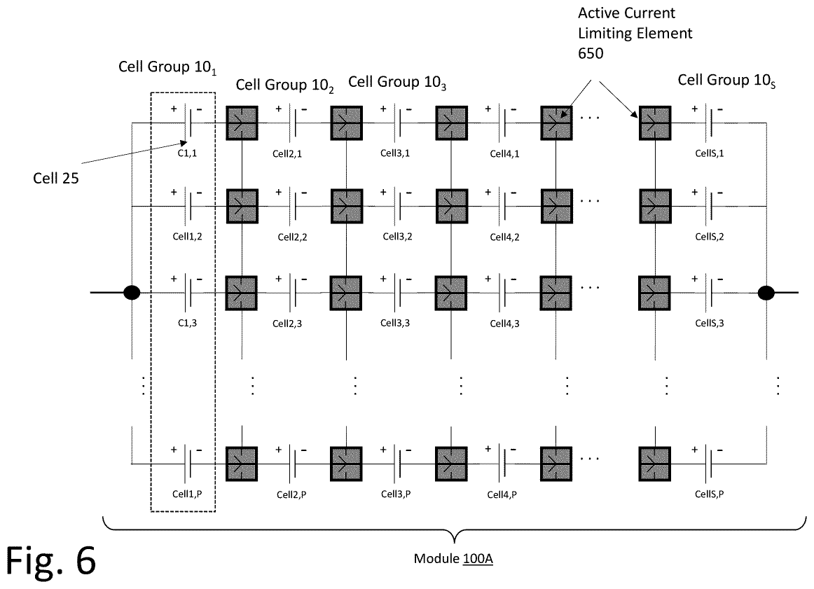

In other aspects of the disclosure, an active current limiting element 650 may be used to isolate a cell 25 to prevent thermal runaway propagation as shown in FIG. 6. Similar to above, the active current limiting element 650 may be positioned in the parallel path between parallelly connected cells 25. The active current limiting element 650 may be placed in the parallel path of the positive terminals, the negative terminals or both the positive terminals and the negative terminals of the parallel connected cells. The active current limiting element 650 does not limit current in the series path (normal charge/discharge operation), but only in the parallel path.

In an aspect of the disclosure, the active current limiting element 650 may be a semiconductor switch. For example, the semiconductor switch may be a Metal Oxide Field Effect Transistor (MOSFET), a bipolar junction transistor (BJT), an insulated-gate bipolar transistor (IGBT) or a thyristor.

In other aspects of the disclosure, the active current limiting element 650 may be DC contactors or relays. The contactors or relays may be selected based on the current/voltage of the cells 25 and module 100 and the device ratings.

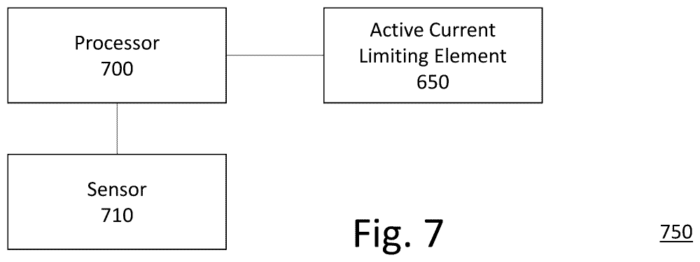

FIG. 7 illustrates a block diagram of a control 750 of the active current limiting element 650 in accordance with aspects of the disclosure.

In an aspect of the disclosure, the active current limiting element 650 may be controlled by a processor 700. The processor 700 may be an FPGA. In other aspects of the disclosure, the processor 410 may be a microcontroller or microprocessor or any other processing hardware such as a CPU or GPU. Memory may be separate from the processor (as or integrated in the same). For example, the microcontroller or microprocessor includes at least one data storage device, such as, but not limited to, RAM, ROM and persistent storage. In an aspect of the disclosure, the processor may be configured to execute one or more programs stored in a computer readable storage device. The computer readable storage device can be RAM, persistent storage or removable storage. A storage device is any piece of hardware that is capable of storing information, such as, for example without limitation, data, programs, instructions, program code, and/or other suitable information, either on a temporary basis and/or a permanent basis. The processor 700 may also include circuitry to bias or provide an analog signal to a gate or base of the semiconductor switch to cause the switch to open as needed or to a terminal of a contactor or relay.

In an aspect of the disclosure, one processor (the same processor) may be used to control all of the active current limiting elements 650. However, in other aspects of the disclosure, each active current limiting element 650 may have its own dedicated processor.

In an aspect of the disclosure, the processor may be incorporated in the BMS.

The control 750 further comprises one or more sensors 710. The sensors 710 may be a voltage sensor, a current sensor, a temperature sensor, a gas sensor or any combination thereof. For example, temperature and/or gas sensors may be positioned adjacent to each cell 25 within the module 100. Voltage and/or current sensors may be connected to the cells 25 to measure the voltage and/or current, respectively.

In an aspect of the disclosure, the storage device may have thresholds associated with different sensors and sensed values for uses in controlling the active current limiting element 650. For example, the storage device may have a temperature threshold above which, the processor 700 causes the active current limiting element 650 to open the connection in the parallel path. Alternatively, the storage device may have a ΔT threshold (change in temperature over a set time), where if the sensed temperature changed more that the stored ΔT threshold, the processor 700 causes the active current limiting element 650 to open the connection in the parallel path. Similarly, the storage may have a current threshold, ΔI threshold (change in current over a set time), and/or a voltage threshold, ΔV threshold (change in voltage threshold) and control based on a comparison of the sensed value with the threshold. Additionally, if the gas sensors detect lithium ion cell off gassing or smoke, processor 700 causes the active current limiting elements 650 to open the connections in the parallel path. The gas sensor(s) may be configured to detect CO₂, CO, H₂, formaldehyde, etc. . . . .

The specific threshold(s) may be based on the parallel cell short circuit current and target response time. Similar to above, the target response time may be application specific where certain applications required quicker response times than other applications.

In an aspect of the disclosure, when the processor 700 causes the active current limiting element 650 to open the connection in the parallel path, the processor 700 may issue a notification by communicating the event electronically. For example, when the module 100 is installed in a vehicle, the processor 700 may cause a notification to be displayed on an instrument panel or an audible notification via speaker.

The instrument panel may be in a flight deck or a control cabin in an airplane. The notification may be in the form of a light indictor. In some aspects of the disclosure, the notification may indicate the specific cell that is isolated to facilitate maintenance.

In an aspect of the disclosure, the processor 700 may receive an instruction to close the active current limiting element 650 after it is opened. This instruction may be after the cell in question has been repaired.

As used herein, the term “processor” may include a single core processor, a multi-core processor, multiple processors located in a single device, or multiple processors in wired or wireless communication with each other and distributed over a network of devices, the Internet, or the cloud. Accordingly, as used herein, functions, features or instructions performed or configured to be performed by a “processor”, may include the performance of the functions, features or instructions by a single core processor, may include performance of the functions, features or instructions collectively or collaboratively by multiple cores of a multi-core processor, or may include performance of the functions, features or instructions collectively or collaboratively by multiple processors, where each processor or core is not required to perform every function, feature or instruction individually. For example, a single FPGA may be used or multiple FPGAs may be used to achieve the functions, features or instructions described herein.

Various aspects of the present disclosure may be embodied as a program, software, or computer instructions embodied or stored in a computer or machine usable or readable medium, or a group of media which causes the computer or machine to perform the steps of the method when executed on the computer, processor, and/or machine. A program storage device readable by a machine, e.g., a computer readable medium, tangibly embodying a program of instructions executable by the machine to perform various functionalities and methods described in the present disclosure is also provided, e.g., a computer program product.

The computer readable medium could be a computer readable storage device or a computer readable signal medium. A computer readable storage device, may be, for example, a magnetic, optical, electronic, electromagnetic, infrared, or semiconductor system, apparatus, or device, or any suitable combination of the foregoing; however, the computer readable storage device is not limited to these examples except a computer readable storage device excludes computer readable signal medium. Additional examples of the computer readable storage device can include: a portable computer diskette, a hard disk, a magnetic storage device, a portable compact disc read-only memory (CD-ROM), a random access memory (RAM), a read-only memory (ROM), an erasable programmable read-only memory (EPROM or Flash memory), an optical storage device, or any appropriate combination of the foregoing; however, the computer readable storage device is also not limited to these examples. Any tangible medium that can contain, or store, a program for use by or in connection with an instruction execution system, apparatus, or device could be a computer readable storage device.

A computer readable signal medium may include a propagated data signal with computer readable program code embodied therein, such as, but not limited to, in baseband or as part of a carrier wave. A propagated signal may take any of a plurality of forms, including, but not limited to, electro-magnetic, optical, or any suitable combination thereof. A computer readable signal medium may be any computer readable medium (exclusive of computer readable storage device) that can communicate, propagate, or transport a program for use by or in connection with a system, apparatus, or device. Program code embodied on a computer readable signal medium may be transmitted using any appropriate medium, including but not limited to wireless, wired, optical fiber cable, RF, etc., or any suitable combination of the foregoing.

In the discussion and claims herein, the term “about” indicates that the value listed may be somewhat altered, as long as the alteration does not result in nonconformance of the process or device. For example, for some elements the term “about” can refer to a variation of ±0.1%, for other elements, the term “about” can refer to a variation of ±1% or ±10%, or any point therein. For example, the term about when used for a measurement in mm, may include +/0.1, 0.2, 0.3, etc., where the difference between the stated number may be larger when the state number is larger. For example, about 1.5 may include 1.2-1.8, where about 20, may include 18.0-22.0.

As used herein, the term “substantially”, or “substantial”, is equally applicable when used in a negative connotation to refer to the complete or near complete lack of an action, characteristic, property, state, structure, item, or result. For example, a surface that is “substantially” flat would either completely flat, or so nearly flat that the effect would be the same as if it were completely flat. “Substantially” when referring to a shape or size may account for manufacturing where a perfect shapes, such as circular or sizes may be difficult to manufacture.

As used herein terms such as “a”, “an” and “the” are not intended to refer to only a singular entity, but include the general class of which a specific example may be used for illustration. As used herein, terms defined in the singular are intended to include those terms defined in the plural and vice versa.

References in the specification to “one aspect”, “certain aspects”, “some aspects” or “an aspect”, indicate that the aspect(s) described may include a particular feature or characteristic, but every aspect may not necessarily include the particular feature, structure, or characteristic. Moreover, such phrases are not necessarily referring to the same aspect. Further, when a particular feature, structure, or characteristic is described in connection with an aspect, it is submitted that it is within the knowledge of one skilled in the art to affect such feature, structure, or characteristic in connection with other aspects whether or not explicitly described.

For purposes of the description hereinafter, the terms “upper”, “lower”, “right”, “left”, “vertical”, “horizontal”, “top”, “bottom”, and derivatives thereof shall relate to a device relative to a floor and/or as it is oriented in the figures or with respect to a surface.

Reference herein to any numerical range expressly includes each numerical value (including fractional numbers and whole numbers) encompassed by that range. To illustrate, reference herein to a range of “at least 50” or “at least about 50” includes whole numbers of 50, 51, 52, 53, 54, 55, 56, 57, 58, 59, 60, etc., and fractional numbers 50.1, 50.2 50.3, 50.4, 50.5, 50.6, 50.7, 50.8, 50.9, etc. In a further illustration, reference herein to a range of “less than 50” or “less than about 50” includes whole numbers 49, 48, 47, 46, 45, 44, 43, 42, 41, 40, etc., and fractional numbers 49.9, 49.8, 49.7, 49.6, 49.5, 49.4, 49.3, 49.2, 49.1, 49.0, etc.

The terminology used herein is for the purpose of describing particular embodiments only and is not intended to be limiting the scope of the disclosure and is not intended to be exhaustive. Many modifications and variations will be apparent to those of ordinary skill in the art without departing from the scope and spirit of the disclosure.

What is claimed is:

1. A battery module comprising:
a plurality of cells mounted within a housing, the housing having a plurality of openings respectively for a corresponding cell;
a plurality of groups of cells, each group comprises a plurality of parallel connected cells from among the plurality of cells, where the plurality of groups is connected in series; and
a plurality of current limiting elements, each current limiting element being electrically connected in a parallel path to one or both terminals of cells which are parallelly connected.

2. The battery module of claim 1, further comprising a first set of busbars, and a second set of busbars, the first set of busbars and the second set of busbars being connected to terminals of the cells and wherein the plurality of current limiting elements is integrated into the first set of busbars, the second set of busbars or both the first set of busbars and the second set of busbars.

3. The battery module of claim 2, wherein the cells have a first end and a second end, wherein the first set of busbars are positioned on the first end and wherein the second set of busbars are positioned on the second end.

4. The battery module of claim 2, wherein the plurality of current limiting elements is connected to both terminals of the cells and wherein the plurality of current limiting elements is integrated into both the first set of busbars and the second set of busbars.

5. The battery module of claim 1, wherein the cells have a first end and a second end and a positive terminal and a negative terminal of the cells are on the first end, wherein the battery module further comprises a first busbar electrically connecting the positive terminal of a first cell with the negative terminal of a second cell, where the first cell and the second cell are serially connected, and a second busbar electrical connecting the positive terminal of third cell with the negative terminal of a fourth cell, where the third cell and the fourth cell are serially connect, wherein the current limited element is in the parallel path between the first cell and the third cell and the second cell and the fourth cell, respectively and connected to the positive and negative terminals of the first cell, the second cell, the third cell and the fourth cell.

6. The battery module of claim 1, wherein the plurality of current limiting elements is configured to prevent thermal runaway from propagating from one cell to another cell.

7. The battery module of claim 1, wherein the plurality of current limiting elements is a passive element.

8. The battery module of claim 7, wherein the passive element is a fuse.

9. The battery module of claim 8, wherein each fuse connects adjacent parallelly connected cells.

10. The battery module of claim 8, wherein each fuse is offset with the openings in the housing.

11. The battery module of claim 8, wherein a short circuit current seen by each fuse for the same group is the same for all of cells within the group.

12. The battery module of claim 8, wherein the fuse is a wire in the parallel path of the parallel connected cells, wherein the wire is connected to busbars which are connected to the cells.

13. The battery module of claim 7, wherein the passive element is a circuit breaker.

14. The battery module of claim 1, wherein the plurality of current limiting elements is an active element.

15. The battery module of claim 14, wherein the active element is a semiconductor switch, relay or contactor.

16. The battery module of claim 15, further comprising a processor configured to control the active element to open upon a detection of an event by a sensor.

17. The battery module of claim 16, further comprising a sensor.

18. A battery pack comprising a plurality of the battery modules of claim 1 connected in series.

19. A battery system comprising a plurality of battery packs of claim 18 connected in parallel.

20. An airplane comprising the battery system of claim 19.

21. A battery module comprising:
a plurality of cells mounted within a housing, the housing having a plurality of openings respectively for a corresponding cell;
a plurality of groups of cells, each group comprises a plurality of parallel connected cells from among the plurality of cells, where the plurality of groups is connected in series; and
a plurality of fuses, each fuse being electrically connected in a parallel path to one or both terminals of cells which are parallelly connected.
